(19) United States
(12) Patent Application Publication
(10) Pub. No.: US 2026/0058080 A1
(43) Pub. Date: Feb. 26, 2026

(54) MAGNETIC SWITCH KEY

(71) Applicant: Shenzhen Feidao technology Co., LTD, Shenzhen (CN)

(72) Inventor: Xueliang LI, Guigang (CN)

(73) Assignee: Shenzhen Feidao technology Co., LTD, Shenzhen (CN)

(21) Appl. No.: 18/928,450

(22) Filed: Oct. 28, 2024

(30) Foreign Application Priority Data
Aug. 26, 2024 (CN) 2024220743519

(51) Int. Cl. H01H 36/00

(52) U.S. Cl. CPC H01H 36/008

(57) ABSTRACT

The present disclosure belongs to the technical field of keyboard keys, and a magnetic switch key is provided. The magnetic switch key comprises a shell and a movable shaft. A perforating hole is formed in a top wall of the shell. The movable shaft is inserted into the perforating hole to be capable of reciprocating motion. The magnetic switch key is more reasonable in magnet layout. The movable magnet can drive the movable shaft to reset in absence of external force. A paragraph hand feeling or linear hand feeling can be realized through the height adjustment of the magnets, so that the using comfort feeling is greatly promoted.

### CROSS-REFERENCE TO RELATED APPLICATIONS

The application claims priority to Chinese patent application No. 2024220743519, filed on Aug. 26, 2024, the entire contents of which are incorporated herein by reference.

### TECHNICAL FIELD

The present disclosure relates to the technical field of keyboard keys, in particular to a magnetic switch key.

### BACKGROUND

Physical keys are very important input and output devices, and are widely used in mobile phones, computers and other electronic devices.

The existing keys are usually installed by springs, which means that springs are used in mechanical keyboards to provide the resilience and tactile sensation of keys. However, certain noise can be produced when keys are pressed by the spring installation method. The springs, as resilience devices of the keys, need to bear long-term pressing and release, which may lead to the fatigue and service life problems of the springs. After long-term use, the elasticity of the springs may gradually weaken, thus affecting the performance of the keyboard. Some keys are replaced by magnets, but the rationality of layout may affect the hand feeling of the keys. Therefore, a magnetic switch key has been designed.

### SUMMARY

The present disclosure aims to provide a magnetic switch key. The magnetic switch key solves the technical problems proposed in the background art.

In order to realize the above purpose, the present disclosure is realized through the following technical scheme. A magnetic switch key includes a shell and a movable shaft. A perforating hole is formed in a top wall of the shell. The movable shaft is inserted into the perforating hole and capable of reciprocating motion. A first insertion hole is formed in the movable shaft. A movable magnet is inserted into the first insertion hole. Second insertion holes are also formed in the top wall of the shell and located on both sides of the perforating hole. Fixed magnets are inserted into the two second insertion holes. Top ends of both side walls of the movable shaft are in the shape of a step. A top end inside the perforating hole is provided with a baffle block. The baffle block is matched with the step on the side walls of the movable shaft to restrict the movable shaft from not taking off from the upper part of the perforating hole.

Opposite sides of the two fixed magnets and the movable magnet are opposite in polarities, and the shell is also provided with a conducting mechanism for inducing the movement of the movable shaft to release electric signals.

Preferably, the conducting mechanism includes a circuit board and conducting adhesive. The bottom of the shell is open. The circuit board is arranged at the bottom of the shell. The conducting adhesive is arranged at the bottom of the movable shaft. The circuit board is provided with a PCB (Printed Circuit Board) circuit at the position corresponding to the conducting adhesive. The conducting adhesive is in contact with the PCB circuit to form a path for switching.

Preferably, the conducting mechanism includes an infrared transmitting element, an infrared receiving element and a shield. The infrared transmitting element and the infrared receiving element are both arranged on an inner side wall of the shell. The shield is fixedly connected to the movable shaft and located between the infrared receiving element and the infrared transmitting element so as to shield light. Light can be released when the movable shaft moves downwards so that the infrared receiving element receives light to produce signals.

Preferably, the conducting mechanism is a Hall element. The Hall element is arranged inside the shell. The movable magnet gets close to the Hall element when the movable shaft moves downwards. A magnetic field changes to produce electric signals.

Preferably, the Hall element is fixedly mounted at the bottom inside the shell at the position corresponding to the movable shaft.

Preferably, the conducting mechanism also includes a reinforcing magnet. The reinforcing magnet is arranged at the bottom of the movable shaft, and the bottom of the reinforcing magnet and the bottom of the movable magnet are the same in magnetic poles for reinforcing the magnetic field.

Preferably, a through hole is formed in the middle of the movable magnet. An inner wall of the first insertion hole is provided with a bulge at the position corresponding to the through hole. The bulge is inserted into the through hole to fix the movable magnet. The surface of the bulge is a spherical surface.

Preferably, an inner wall of the second insertion hole is provided with a limited block, and the limited block is in contact with the bottom of the fixed magnet.

Through the above-mentioned technical scheme, the present disclosure has the following beneficial effects.

The magnetic switch key is more reasonable in magnet layout. Magnetic attraction force of the fixed magnets and the movable magnet can remain all the time. Thus, when the movable shaft is pushed, the magnetic attraction force of the fixed magnets and the movable magnet can remain all the time at a reset position of the movable shaft. The fixed magnets can attract the movable magnet all the time to reset. The movable magnet can drive the movable shaft to reset in absence of external force. A paragraph hand feeling or linear hand feeling can be realized through the height adjustment of the magnets, so that the using comfort feeling is greatly promoted.

### BRIEF DESCRIPTION OF THE DRAWINGS

FIG. 1 is an internal structural schematic diagram in the first embodiment of the present disclosure.

FIG. 2 is a side section view in the first embodiment of the present disclosure.

FIG. 3 is an internal structural schematic diagram in the second embodiment of the present disclosure.

FIG. 4 is an internal structural schematic diagram in the third embodiment of the present disclosure.

FIG. 5 is an internal structural schematic diagram in the fourth embodiment of the present disclosure.

Reference signs: 1, shell; 2, movable shaft; 3, perforating hole; 4, first insertion hole; 5, movable magnet; 6, second insertion hole; 7, fixed magnet; 8, baffle block; 9, conducting mechanism; 10, circuit board; 11, conducting adhesive; 12, PCB circuit; 13, infrared transmitting element; 14, infrared receiving element; 15, shield; 16, Hall element; 17, reinforcing magnet; 18, through hole; 19, bulge; and 20, limited block.

### DETAILED DESCRIPTION OF THE EMBODIMENTS

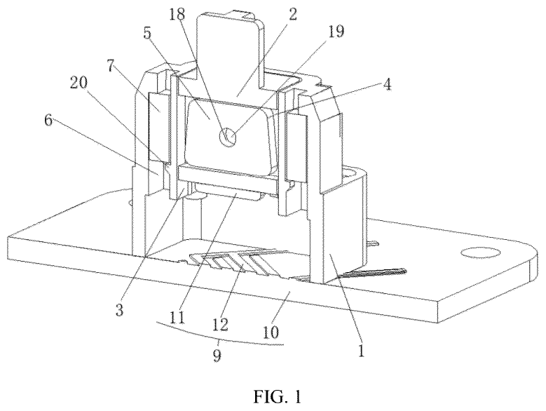

Referring to FIG. 1 to FIG. 5, the present disclosure provides a technical scheme. A magnetic switch key includes a shell 1 and a movable shaft 2. A perforating hole 3 is formed in a top wall of the shell 1. The movable shaft 2 is inserted into the perforating hole 3 and capable of reciprocating motion. A first insertion hole 4 is formed in the movable shaft 2. A movable magnet 5 is inserted into the first insertion hole 4. Second insertion holes 6 are also formed in the top wall of the shell 1 and located on both sides of the perforating hole 3. Fixed magnets 7 are inserted into the two second insertion holes 6. Top ends of both side walls of the movable shaft 2 are in the shape of a step. A top end inside the perforating hole 3 is provided with a baffle block 8. The baffle block 8 is matched with the step on the side walls of the movable shaft 2 to restrict the movable shaft 2 from not taking off from the upper part of the perforating hole 3.

When the baffle block 8 as shown in attached figures of the present disclosure is in contact with the movable shaft 2, the movable magnet 5 and the fixed magnets 7 are located at the same height. In practical production, the heights of the fixed magnets 7 and the movable magnet 5 can also be adjusted to obtain different pressing hand feelings. Opposite sides of the two fixed magnets 7 and the movable magnet 5 are opposite in polarities. The shell 1 is also provided with a conducting mechanism 9 for inducing the movement of the movable shaft 2 to release electric signals.

A through hole 18 is formed in the middle of the movable magnet 5. An inner wall of the first insertion hole 4 is provided with a bulge 19 at the position corresponding to the through hole 18. The bulge 19 is inserted into the through hole 18 to fix the movable magnet 5. The surface of the bulge 19 is a spherical surface.

An inner wall of the second insertion hole 6 is provided with a limited block 20, and the limited block 20 is in contact with the bottom of the fixed magnet 7.

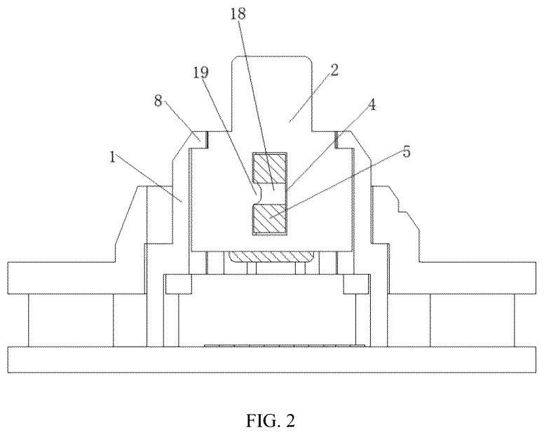

In the first embodiment, referring to FIG. 1 and FIG. 2, the conducting mechanism 9 includes a circuit board 10, conducting adhesive 11 and a PCB circuit 12. The bottom of the shell 1 is open. The circuit board 10 is arranged at the bottom of the shell 1. The conducting adhesive 11 is arranged at the bottom of the movable shaft 2. The circuit board 10 is provided with a PCB circuit 12 at the position corresponding to the conducting adhesive 11. The conducting adhesive 11 is in contact with the PCB circuit 12 to form a path for switching.

A conventional conduction method adopted in the embodiment is lower in production cost.

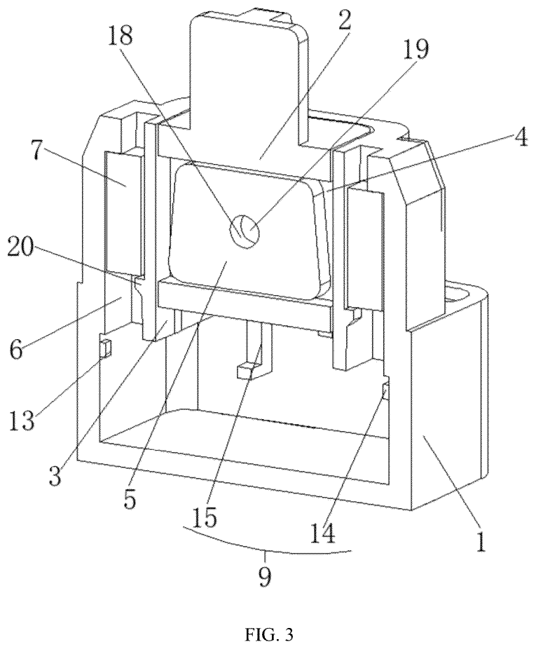

In the second embodiment, referring to FIG. 3, the conducting mechanism 3 includes an infrared transmitting element 13, an infrared receiving element 14 and a shield 15. The infrared transmitting element 13 and the infrared receiving element 14 are both arranged on an inner side wall of the shell 1. The shield 15 is fixedly connected to the movable shaft 2 and located between the infrared receiving element 14 and the infrared transmitting element 13 so as to shield light. Light can be released when the movable shaft 2 moves downwards so that the infrared receiving element 14 receives light to produce signals. The shield 15 used in the embodiment is a plate in which a strip-shaped hole is formed. When the movable shaft 2 drives the shield 15 to move downwards, the strip-shaped hole is located between the infrared receiving element 14 and the infrared transmitting element 13, and light cannot be shielded. When the movable shaft 2 resets, the shield 15 shields light again, so that switching of the key is realized. In order to realize the above function, different states can also be designed. A reflector can also be mounted on the shield 15 to reflect light, so that the light is received by the infrared receiving element 14. The final goal is that up-and-down movement of the movable shaft 2 is associated with whether the infrared receiving element 14 can receive light or not, and is not discussed here.

An infrared induction method adopted in the embodiment recognizes pressing signals, and is higher in reliability and stability and more sensitive in reaction.

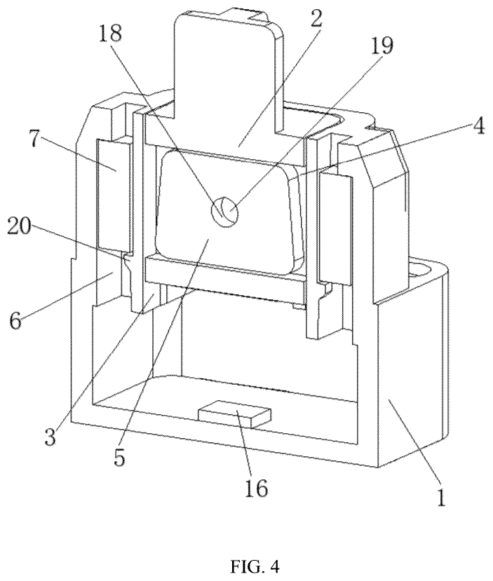

In the third embodiment, referring to FIG. 4, the conducting mechanism 9 is a Hall element 16. The Hall element 16 is arranged inside the shell 1. The movable magnet 5 gets close to the Hall element 16 when the movable shaft 2 moves downwards. A magnetic field changes to produce electric signals.

The Hall element 16 is fixedly mounted at the bottom inside the shell 1 at the position corresponding to the movable shaft 2.

In the embodiment, the pressing signals are recognized by the Hall element in the embodiment. Different signal strength is produced by the Hall element according to different pressing depths of the movable shaft, so that the functionality of the key is promoted.

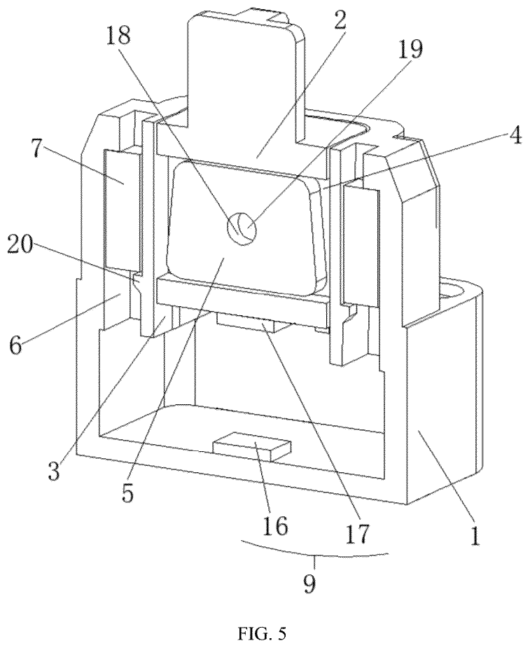

In the fourth embodiment, referring to FIG. 5, the embodiment is based on the third embodiment. The conducting mechanism 9 also includes a reinforcing magnet 17. The reinforcing magnet 17 is arranged at the bottom of the movable shaft 2, and the bottom of the reinforcing magnet 17 and the bottom of the movable magnet 5 are the same in magnetic poles for reinforcing the magnetic field to avoid from influencing the operation of the Hall element caused by magnetism weakening since the movable magnet 5 is blocked by the movable shaft 2.

Various modifications to the embodiments are obvious to those skilled in the art, and general principles defined in the present disclosure may be implemented in other embodiments without departing from the spirit or scope of the present disclosure. Therefore, the present disclosure will not be limited to the embodiments described in the present disclosure but extends to the widest scope that complies with the principles and novelty disclosed in the present disclosure.

What is claimed is:

1. A magnetic switch key, comprising a shell and a movable shaft, wherein a perforating hole is formed in a top wall of the shell, the movable shaft is inserted into the perforating hole and capable of reciprocating motion, a first insertion hole is formed in the movable shaft, a movable magnet is inserted into the first insertion hole, second insertion holes are also formed in the top wall of the shell and located on both sides of the perforating hole, fixed magnets are inserted into the two second insertion holes, top ends of both side walls of the movable shaft are in the shape of a step, a top end inside the perforating hole is provided with a baffle block, and the baffle block is matched with the step on the side walls of the movable shaft to restrict the movable shaft from not taking off from the upper part of the perforating hole;
opposite sides of the two fixed magnets and the movable magnet are opposite in polarities, and the shell is also provided with a conducting mechanism for inducing the movement of the movable shaft to release electric signals.

2. The magnetic switch key according to claim 1, wherein the conducting mechanism comprises a circuit board and conducting adhesive, the bottom of the shell is open, the circuit board is arranged at the bottom of the shell, the conducting adhesive is arranged at the bottom of the movable shaft, the circuit board is provided with a PCB (Printed Circuit Board) circuit at the position corresponding to the conducting adhesive, and the conducting adhesive is in contact with the PCB circuit to form a path for switching.

3. The magnetic switch key according to claim 1, wherein the conducting mechanism comprises an infrared transmitting element, an infrared receiving element and a shield, the infrared transmitting element and the infrared receiving element are both arranged on an inner side wall of the shell, the shield is fixedly connected to the movable shaft and located between the infrared receiving element and the infrared transmitting element so as to shield light, and light can be released when the movable shaft moves downwards so that the infrared receiving element receives light to produce signals.

4. The magnetic switch key according to claim 1, wherein the conducting mechanism is a Hall element, the Hall element is arranged inside the shell, the movable magnet gets close to the Hall element when the movable shaft moves downwards, and a magnetic field changes to produce electric signals.

5. The magnetic switch key according to claim 4, wherein the Hall element is fixedly mounted at the bottom inside the shell at the position corresponding to the movable shaft.

6. The magnetic switch key according to claim 5, wherein the conducting mechanism also comprises a reinforcing magnet, the reinforcing magnet is arranged at the bottom of the movable shaft, and the bottom of the reinforcing magnet and the bottom of the movable magnet are the same in magnetic poles for reinforcing the magnetic field.

7. The magnetic switch key according to claim 6, wherein a through hole is formed in the middle of the movable magnet, an inner wall of the first insertion hole is provided with a bulge at the position corresponding to the through hole, the bulge is inserted into the through hole to fix the movable magnet, and the surface of the bulge is a spherical surface.

8. The magnetic switch key according to claim 7, wherein an inner wall of the second insertion hole is provided with a limited block, and the limited block is in contact with the bottom of the fixed magnet.
